(19) United States
(12) Patent Application Publication
(10) Pub. No.: US 2017/0273133 A1
(43) Pub. Date: Sep. 21, 2017

(54) Communication Device for an Action Force and Communication Method

(71) Applicant: Rheinmetall Defence Electronics GmbH, Bremen (DE)

(72) Inventors: Patrick Galler, Bremen (DE); Enrico Grossmann, Bremen (DE)

(21) Appl. No.: 15/532,031

(22) PCT Filed: Nov. 18, 2015
(86) PCT No.: PCT/EP2015/076976

§ 371 Date: May 31, 2017

(30) Foreign Application Priority Data
Dec. 1, 2014 (DE) 10 2014 117 585.9
Aug. 10, 2015 (DE) 10 2015 113 139.0

(51) Int. Cl. H04W 76/04; H04W 4/00; F41A 33/02; G09B 9/00

(52) U.S. Cl. CPC H04W 76/045; G09B 9/003; H04W 4/008; F41A 33/02; H04W 88/06

(57) ABSTRACT

A communication device for an action force for communicating with a control center during a simulation of a security task is provided. The communication device includes a mobile radio device with a transceiver unit for providing at least two separate, independent communication connections to the control center and a modem for coupling at least one detector for detecting at least one simulation information relating to the simulation with the mobile radio device.

The present invention relates to a communication device for an action force for communicating with a control center during a simulation of a security task. Moreover, the present invention relates to a system having a control center and a plurality of communication devices as well as a communication method for communicating between a communication device for an action force and a control center during a simulation of a security task.

The technical background of the present invention relates to the communication between an action force and a control center during the simulation of a security task such as a live simulation of a BOS-security task (BOS, administrations and organizations having security tasks (german: Behorden and Organisationen mit Sicherheitsaufgaben). For example, the live simulation relates to a field exercise of soldiers. As is known, duel simulators are employed in the shooting training with straight directed weapons as well as in field exercise centers. For this purpose, the information about the shooter, about the shot, about the type of weapon, and the employed ammunition is transmitted to the target via a directed and coded infrared laser beam. The action force representing a potential target carries at least one detector which can detect a striking laser beam. This detector is connected, via cable, to evaluation electronics, the so called participant unit, which is carried by the action force.

For example, the sensor distance and the sensor position are selected depending on the diameter of the striking laser beam such that a meaningful predication can be made about the strike point of the laser beam on the action force or the participant and therefore about the effect of the weapon in real life. For that purpose, an evaluation system evaluating the simulated hit based on a recorded vulnerability model is provided in the participant unit. In addition, the participant unit includes a radio system which can get in radio contact with the field exercise control center or the control center.

For example, the document DE 10 2006 042 432 A1 describes a communication method between components of a wireless short range network in the context of a battle field simulation, wherein one component is configured as a master and the other components are configured as slaves and the slaves synchronously or asynchronously transmit data to the master via an operation channel, wherein synchronous slaves transmit data time windows fixedly assigned to them and asynchronous slaves transmit data event based. If this short range network fails, it can lead in an adverse manner to limitations and problems during the battle field simulation.

Therefore, an object of the present invention is to provide an improved communication between an action force and a control center during a simulation of a security task.

According to a first aspect, a communication device for an action force for communicating with a control center during a simulation of a security task is provided. Here, the communication device comprises a mobile radio device having a transceiver unit for providing at least two separate, independent communication connections to the control center and a modem for coupling at least one detector for detecting at least one simulation information regarding the simulation with the mobile radio device.

The simulation of a security task is, for example, a live simulation of a BOS-security task (BOS, administrations and organizations having security tasks). For example, the live simulation relates to a field exercise of soldiers as action forces. Further examples for action forces are firefighters, police, technical emergency service personnel and the like.

The mobile radio device is particularly a smart phone. The at least two communication connections, which can be provided by the transceiver unit, are separated from another. Thus, the at least two communication connections are physically different. For example, different frequencies or different frequency bands are employed for the two separated communication connections. Moreover, the two separate communication connections are independent from one another. In particular, this means that different technologies, such as different mobile radio standards, are used for the at least two communication connections. The at least two separate, independent communication connections can also be referred to as separate, independent communication channels.

By providing the at least two separate, independent communication connections between the mobile radio device and the control center, the reliability of the communication between the mobile radio device and the control center is increased. If, for example, one of the employed technologies of one communication connection is not operational at a particular point in time, the information and data can be exchanged between the mobile radio device and the control center via the at least one other communication connection. Moreover, it is possible that individual frequencies or frequency bands are disturbed during a simulation of the security task at a particular point in time. Also in this case, the transceiver unit may provide the communication between the mobile radio device and the control center optionally via the at least one other, independent communication connection.

In the example of a live simulation of a field exercise, the simulation information indicates for example a shooting of a laser weapon of the action force as a simulated shot or a detection of a laser beam by a detector attached on the action force as a simulated hit.

In particular, the control center may also simulate the fail of a communication connection during a field exercise, for example by specifically disturbing a communication connection. The action force can afterwards re-establish the communication with the control center by a suitable choice of the at least one other communication connection.

Overall, the transceiver unit can establish N, where N≧2, separate, independent communication connections or communication channels to the control center. In particular, the N communication connections are based on different technologies, use different frequency bands, and have different ranges. For example, the transceiver unit can establish three communication connections to the control center, one via WLAN, one via GPRS/LTE, and one via TETRA-radio.

Furthermore, it is possible that the transceiver unit transmits positional data of the action force to the control center optionally via each of the N communication connections. Here, the N communication connections can particularly include GPS (global positioning system), IPS (indoor positioning system), or a mobile radio standard such as UMTS or LTE. For determining the position of the action force, the communication device may use, for example, sensors such as gyro sensors, acceleration sensors, pedometers, altimeters, and the like.

The communication device may also be referred to as a smart-player-unit. The modem is particularly a PAN-modem (PAN; personal area network). Due to the connection of the PAN-radio via the modem of the communication device, different detectors, sensors, and/or weapons, such as laser weapons or PAN-based weapons, can be connected in a modular manner. By using different communication connections, a local communication infrastructure can be used depending on the operation location. In particular, this can be especially advantageous in disaster control.

According to an embodiment, the modem is configured to modulate a simulation signal carrying the simulation information and to transmit the modulated simulation signal to the transceiver unit. Here, the transceiver unit is configured to transmit the modulated simulation signal to the control center optionally via each one of the at least two separate, independent communication connections.

Depending on the received simulation signal, the control center can determine the status of the action force. For example, the control center can determine that the action force has been hit by another laser weapon and can therefore no longer participate in the field exercise. Moreover, the control center can control, upon reception of the simulation signals of a plurality of communications devices and therefore of a plurality of action forces, the field exercise depending on the received simulation signals.

According to a further embodiment, the communication device, more particularly the mobile radio device, includes a control computer, which is for example configured as a micro controller. In particular, the control computer is configured to control the transceiver unit and preferably the modem as well. Further, the control computer can be configured to perform a computation of a GPS-position of the action force and to transmit the computed GPS-position to the control center via the transceiver unit. Moreover, the control computer can, in the case of the field exercise, perform an injury computation of the action force and can transmit the injury computation to the control center optionally via each one of the at least two separate, independent communication connections.

Furthermore, the control computer can compute an area-weapon-effect-simulation which includes for example visualized mine fields, mine corridors, artillery barrage, mortars, N/B/C-agents, or functional areas. Moreover, the control computer can initiate a self-test of the devices coupled via the PAN-modem and can transmit the result data of the self-test to the control center.

Furthermore, it is possible that the mobile radio device receives data relating to a supply with ammunition. This data can be processed by the control computer and forwarded to the connected PAN-weapons via the modem. Moreover, it is possible that the mobile radio device receives new and/or updated status reports from the control center. These status reports are then processed by the control computer and can accordingly influence the battle simulation. Also, the transceiver unit can transmit acoustical and/or optical notifications from the action force about specific statuses such as injury degrees, system states such as charge of battery or radio connection to the control center via the at least two separate, independent communication connections.

According to a further embodiment, the modem is configured to couple a number of infrared detectors and a number of laser weapons with the mobile radio device.

Furthermore, the modem is configured to couple also PAN-based weapons such as dry-fire weapons. Also, the modem is configured to process and transmit PAN-kill codes. The infrared detector is preferably configured to receive position codes, such as indoor-positioning-codes, and laser codes and to transmit the received data to the mobile radio device via the modem.

Here, a laser weapon is, in particular, a laser for emitting a coded laser beam by the operation weapon as a simulated shot. An infrared detector is, in particular, a detector for detecting an emitted coded laser beam as a simulated shot from the action force.

According to a further embodiment, the mobile radio device is configured to use different communication standards for establishing the at least two separate, independent communication connections.

The different communication standards include preferably at least two of the following standards: GPRS, UMTS, LTE, WLAN, Bluetooth, TETRA-radio.

According to a further embodiment, the mobile radio device is a smart phone.

In particular, a smart phone is a mobile cell telephone with an integrated touch sensitive display.

According to a further embodiment, a mobile radio device includes a gyro sensor, an acceleration sensor, a pedometer, a pulse monitor, an altimeter, and/or a vibration signal generator.

Due to the vibration signal generator, a close-missed shot signalization by the combatant can be indicated to the action force in case of a battle simulation. Via the pedometer and preferably via other entities such as a pulse monitor, the physiological and/or psychological status, particularly the stress level, of the action force can be measured and reported to the control center via the mobile radio device. Thereby, the evaluation depth of the field exercise is significantly increased.

According to a further embodiment, the modem is integrated into the mobile radio device.

The integration of the modem into the mobile radio device results in a notably space saving embodiment. Such a space saving embodiment has particularly the advantage during handling by the action force.

According to a further embodiment, the modem is arranged external to the mobile radio device and can be coupled to the mobile radio device via a first specific interface. The first specific interface is preferably a Bluetooth interface or an USB interface.

This embodiment having the external modem has the advantage of a notable modularity of the communication device, since different modems can be externally connected in a simple manner. Also, the exchange of a defect modem is therefore particularly simple.

According to a further embodiment, the device comprises an external power supply unit. The external power supply unit can be preferably coupled to the mobile radio device via a second specific interface. The external power supply unit is, for example, a powerbank. The second specific interface is, for example, a USB interface.

The external power supply unit can preferably supply both the mobile radio device and the modem with electrical energy. In particular, several external power supply units can also be coupled to the mobile radio device.

According to a further embodiment, the transceiver unit is configured to optionally receive voice and/or data signals transmitted from the control center via each one of the at least two separate independent communication connections. Here, the modem is configured to modulate the voice and/or data signals received by the transceiver unit and to transmit the modulated voice and/or data signals to the at least one output device.

Thereby, the control center can preferably transmit orders and instructions to the action force via the voice and/or data signals. Thereby, the control of the field exercise is significantly improved as well as simplified.

According to a further embodiment, the output device comprises a loudspeaker and/or a display for outputting the voice and/or data signals transmitted by the modem.

Because of the use of the output device, which can be controlled by the control center via the mobile radio device and the modem, the communication between the action force and the control center can be improved. Moreover, this allows for an improved exercise control due to the possibility of directly addressing action forces. For example, it is possible via control of the loudspeaker by the control center to make announcements to the action forces or to announce breaks. Moreover, an individual control of a respective action force is possible. During a field exercise, the control center can therefore, for example, reroute a soldier to a combatant. This can also be referred to as a sabotage function.

According to a further embodiment, the transceiver unit is configured to receive a control signal for controlling the output device transmitted by the control center optionally via each one of the at least two separate, independent communication connections, wherein the modem is configured to modulate the control signal received by the transceiver unit and to transmit the modulated control signal for controlling the output device to that output device.

Moreover, it is possible that the control center controls coupled detectors and weapons via the control signal or control signals.

For example, a weapon can thereby be switched off by the control center, whereby a defect of the weapon in the field exercise can be simulated.

According to a further embodiment, the device comprises at least one input device for providing voice and/or data signals upon a voice and/or data input by the action force.

According to a further embodiment, the input device includes a microphone, a camera, and/or a touch sensitive display.

Because of this, the audio data acquisition, particularly during the field exercise, of each action force by recording via microphone and the transmission by the transceiver unit optionally via the at least two separate, independent communication connections can be improved. Furthermore, a transmission of photo data and/or video data, particularly in real time, by the action force can thereby be situationally performed. Using the transmission of the control signals of the control center to the communication device, the control center can also trigger such a recording. Because of this, even talks between the various action forces can be recorded. In return, this results in a good documentation of faults and associated therewith, an enhanced reliability due to the evaluation of the faults. Overall, the evaluation of the field exercise is hereby significantly improved.

Because of this, the control center can also perform a local exercise control of an action force or a certain group of action forces, particularly without the intervention of a referee. Because of this, personnel can be reduced during a field exercise. A further advantage of this is that it can be waived on referees to a great extent, which may distort the field exercise on site due to their presence. In particular, during the simulation of house-to-house fighting, waving on referees directly in a house is particularly advantageous. Instrumentation in the building, particularly cameras, can also be reduced, since the cameras of the communication devices of the action forces can be utilized for this purpose. Overall, this results in reduction possibilities in personnel and instrumentation. Hereby, costs are reduced.

According to a further embodiment, the modem is configured to modulate the voice and/or data signals provided by the input device and to transmit the modulated voice and/or data signals to the transceiver unit, wherein the transceiver unit is configured to transmit the modulated voice and/or data signals to the control center optionally via each one of the at least two separate, independent communication connections.

According to a further embodiment, the device comprises at least one sensor for providing sensor signals. Examples of such a sensor are position sensors, pressure sensors, temperature sensors, gyro sensors, acceleration sensors, pedometers, pulse monitors, and altimeters.

Due to the sensor signals, the control center can, in particular, significantly improve the evaluation as well as the exercise control.

According to a further embodiment, the modem is configured to modulate the sensor signals provided by the sensor and to transmit the modulated sensor signals to the transceiver unit. Here, the transceiver unit is configured to transmit the modulated sensor signal to the control center optionally via each one of the at least two separate, independent communication connections.

According to a second aspect, a system with a control center and with a plurality of communication devices is provided, wherein a respective communication device is embodied according to the first aspect or according to one of the embodiments of the first aspect.

According to a further embodiment, the communication devices are configured to form an ad-hoc network. Here, the ad-hoc network is a radio network which connects two or more communication devices to an intermeshed web.

According to a third aspect, a communication method for communicating between a communication device for an action force and a control center during a simulation of a security task is provided. The method includes the following steps a) and b):
a) equipping the communication device with a mobile radio device which comprises a transceiver unit for providing at least two separate, independent communication connections to the control center and with a modem for coupling at least one detector for detecting at least one simulation information relating to the simulation with the mobile radio device, and
b) transmitting voice and/or data signals and/or one of the simulation signals carrying the simulation information optionally via each one of the at least two separate, independent communication connections between the transceiver unit and the control center.

The embodiments and features described with reference to the device apply mutatis mutantis to the method of the present invention.

According to a fourth aspect, a computer program product is provided which causes the execution of step b) on a program controlled entity.

A computer program product, such as a computer program means, may be provided or delivered as a recording means such as a memory card, USB-stick, CD-ROM, DVD or also in form of a downloadable file from a server in a network. This can, for example, be achieved in a wireless communication network by the transmission of a respective file having the computer program product or the computer program means.

Further possible implementations of the invention also encompass combinations—that are not explicitly mentioned herein—of features described above or below with regard to the embodiments. The person skilled in the art may also add individual or isolated aspects to the most basic form of the invention as improvements or additions.

In the following, the invention will be described in detail based on preferred embodiments with reference to the accompanying drawings.

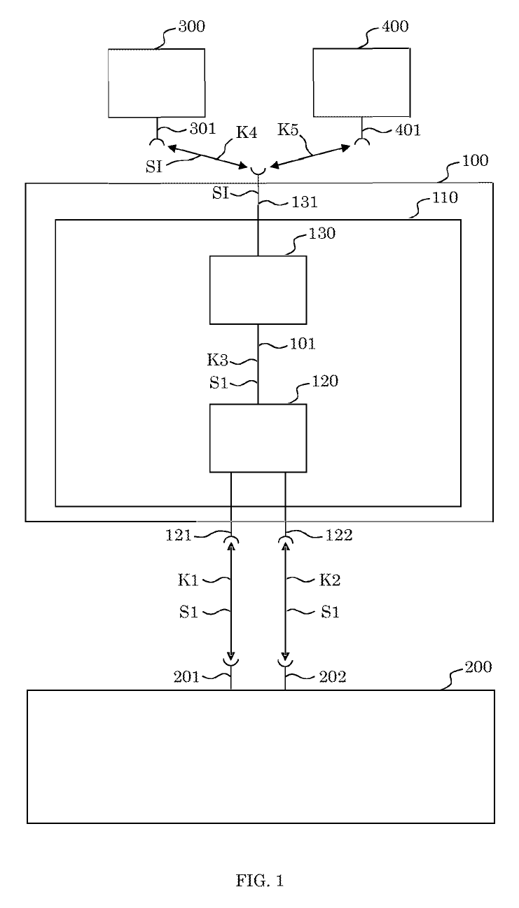

FIG. 1 shows a schematic block diagram of a first embodiment of a communication device for an action force for communicating with a control center during a simulation of a security task;

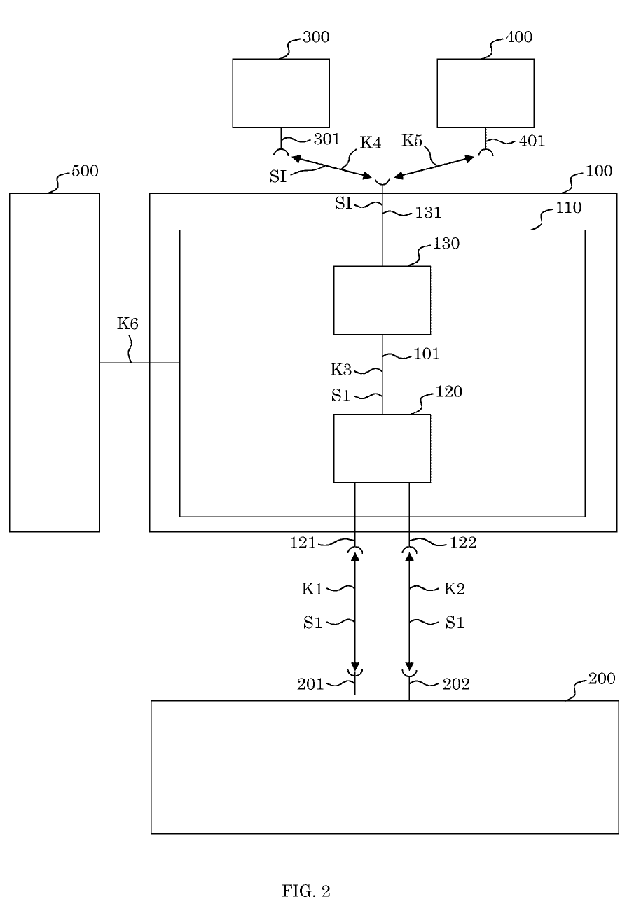

FIG. 2 shows a schematic block diagram of a second embodiment of a communication device for an action force for communicating with a control center during a simulation of a security task;

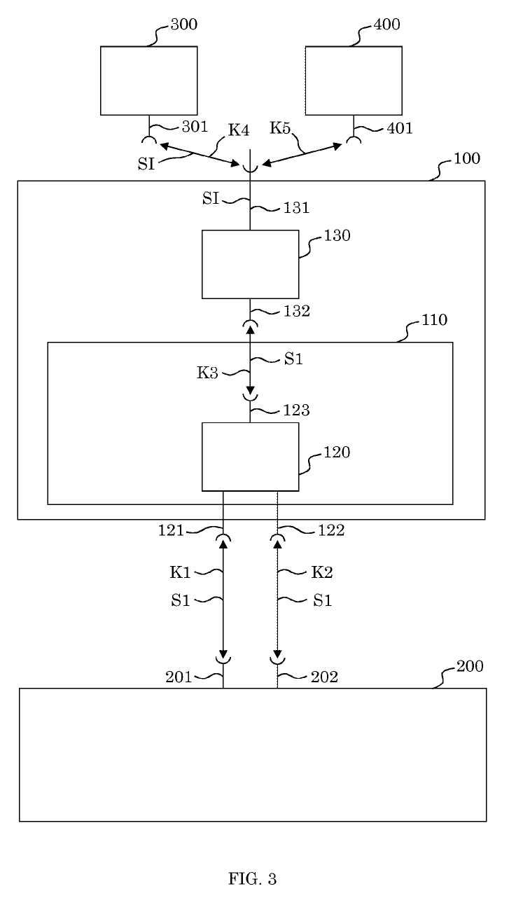

FIG. 3 shows a schematic block diagram of a third embodiment of a communication device for an action force for communicating with a control center during a simulation of a security task;

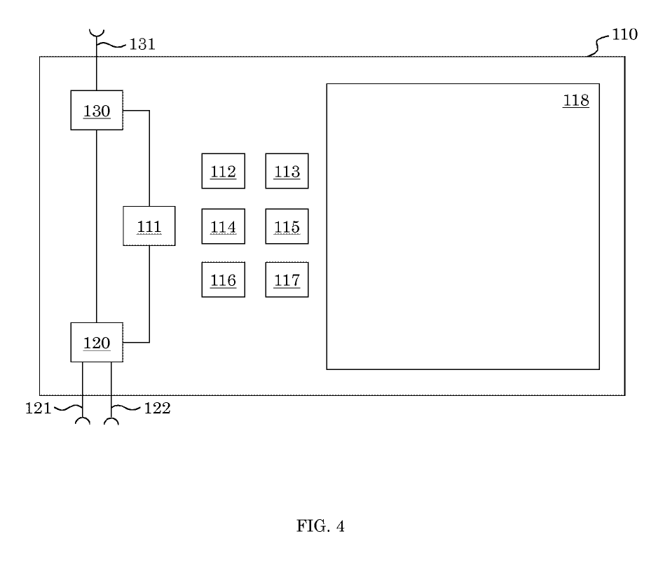

FIG. 4 shows a schematic block diagram of an embodiment of a mobile radio device of the communication device according to FIG. 1, FIG. 2, or FIG. 3;

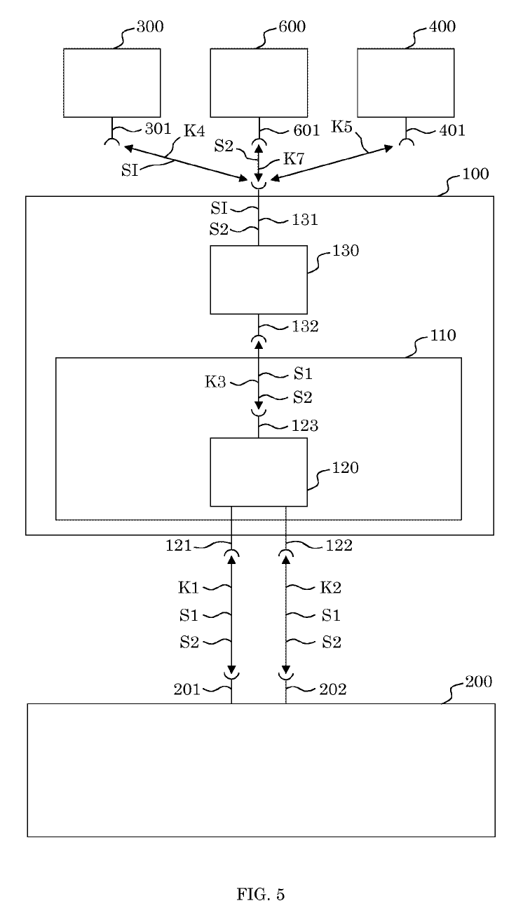

FIG. 5 shows a schematic block diagram of a fourth embodiment of a communication device for an action force for communicating with a control center during a simulation of a security task;

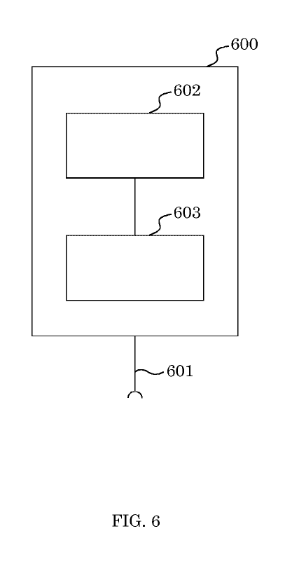

FIG. 6 shows a schematic block diagram of an embodiment of an output device of the communication device according to FIG. 5;

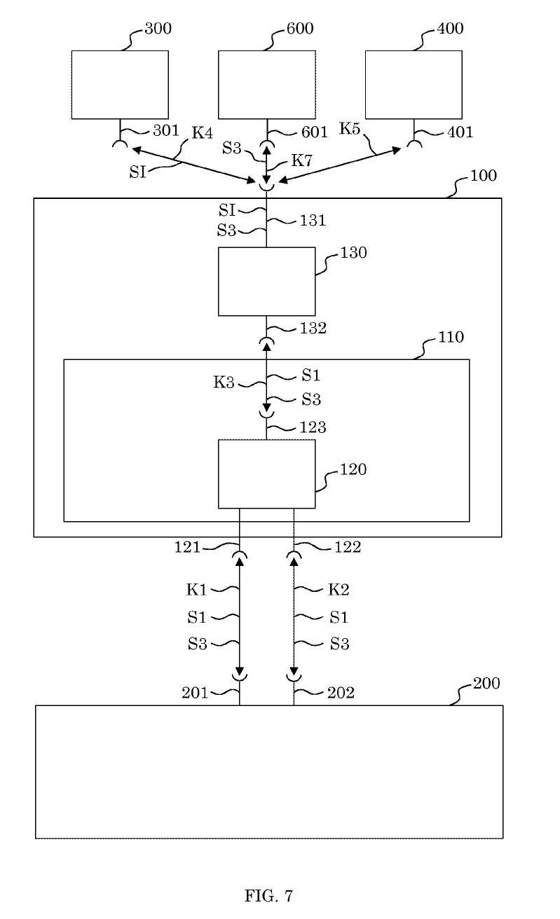

FIG. 7 shows a schematic block diagram of a fifth embodiment of a communication device for an action force for communicating with a control center during a simulation of a security task;

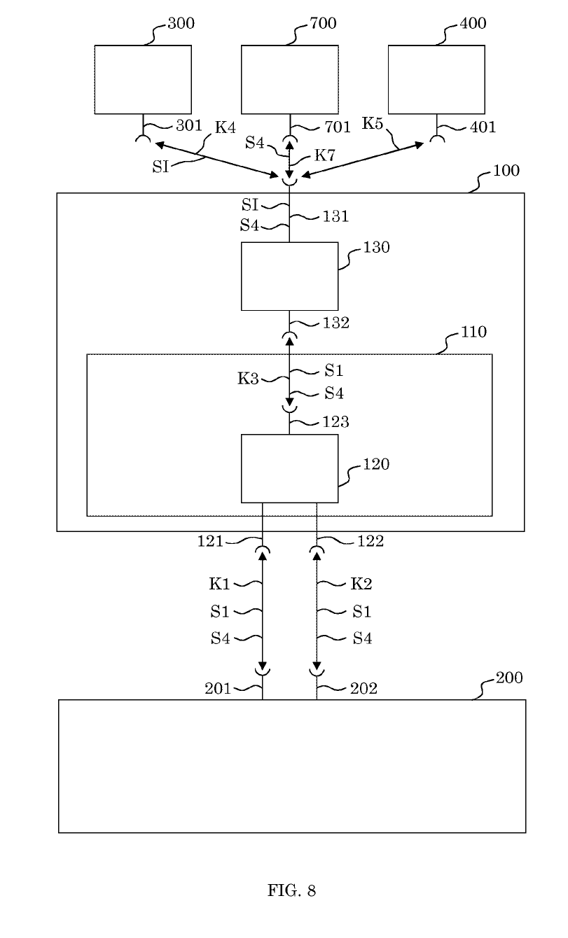

FIG. 8 shows a schematic block diagram of a sixth embodiment of a communication device for an action force for communicating with a control center during a simulation of a security task;

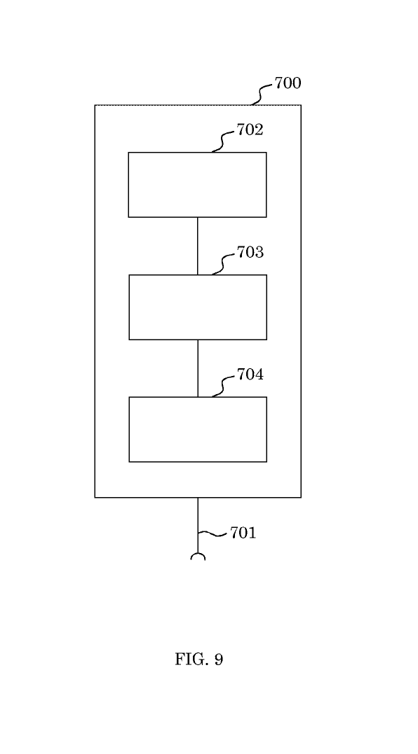

FIG. 9 shows a schematic block diagram of an embodiment of an input device of the communication device according to FIG. 8;

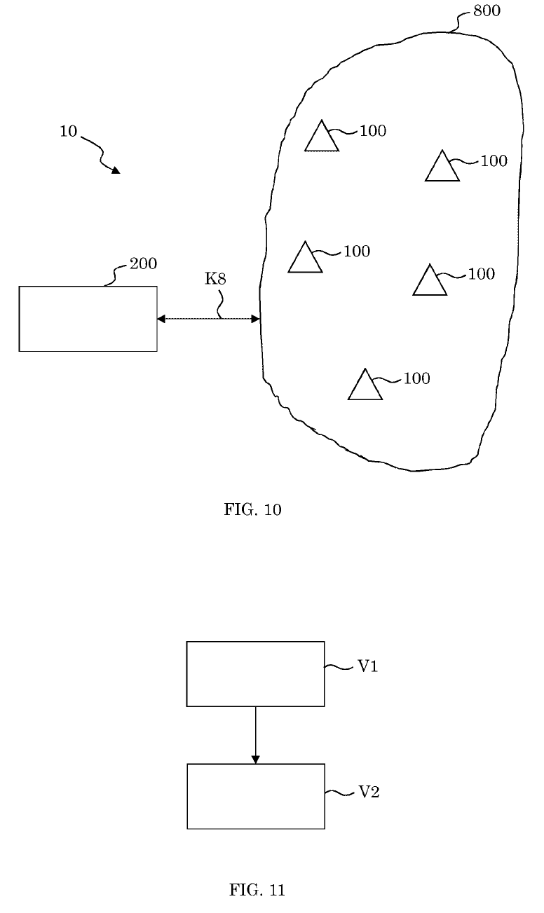

FIG. 10 shows a schematic block diagram of an embodiment of a system with a control center and with a plurality of communication devices; and

FIG. 11 shows a schematic flow chart of an embodiment of a communication method for communicating between a communication device for an action force and a control center during a simulation of a security task.

In the Figures, like reference numerals designate like or functionally equivalent elements, unless otherwise indicated.

In FIG. 1, a schematic block diagram of a first embodiment of a communication device 100 for an action force for communicating with a control center 200 during a simulation of a security task is shown. The control center 200 may also referred to as a central control center or a center.

The simulation of a security task is, for example, a live simulation of a BOS-security task (BOS, administrations and organizations having security tasks). For example, the live simulation relates to a field exercise of soldiers as action forces. Further examples for action forces are firefighters, police, technical emergency service personnel, and the like.

The communication device 100 of FIG. 1 includes a mobile radio device 110 having a transceiver unit 120 and a modem 130.

The transceiver unit 120 is configured to provide at least two separate, independent communication connections K1, K2 to the control center 200.

For this, the transceiver unit 120 has a first interface unit 121 and a second interface unit 122. Accordingly, the control center 200 includes a first interface unit 201 and a second interface unit 202. A first communication connection K1 is established, for example, between the first interface unit 121 of the transceiver unit 120 and the first interface unit 201 of the control center 200. A second communication connection K2 is established between the second interface unit 122 of the transceiver unit 120 and the second interface unit 202 of the control center 200.

In particular, the communication connections K1 and K2 are radio communication connections. The radio communication connections K1, K2 can also be referred to as radio communication channels or communication channels. For establishing a respective radio communication connection K1, K2, the respective interface unit 121, 122, 201, 202 includes preferably a respective antenna.

The example of FIG. 1 shows two separate, independent communication connections K1, K2 between the transceiver unit 120 and the control center 200. In general, there are N, where N≧2, separate, independent communication connections K1, K2 established between the transceiver unit 120 and the control center 200. Here, the mobile radio device 120 and particularly the transceiver unit 120 are configured to employ different communication standards for establishing the at least two separate, independent communication connections K1, K2. Examples for the employed communication standards include GPRS, UMTS, LTE, TETRA-radio, WLAN, and Bluetooth.

The transceiver unit 120 and the modem 130 are connected for establishing a communication connection K3 via a wire-bound interface 101, for example. The wire-bound interface 101 may include ports at the transceiver unit 120 and the modem 130 and a connecting wire, for example. Alternatively, the transceiver unit 120 and the modem 130 may also be provided in a mutual device such as a control computer.

The modem 130 is configured to couple at least one detector 300 for detecting at least one simulation information SI regarding the simulation with the mobile radio device 110.

In particular, the modem 130 is configured to couple a number of infrared detectors 300 and a number of network based weapons 400 to the mobile radio device 110. Without loss of generality, the example in FIG. 1 shows one infrared detector 300 and one laser weapon 400.

For this, the modem 130 has an interface unit 131, the detector 300 has a corresponding interface unit 301, and the laser weapon 400 has an interface unit 401. The respective interface unit 131, 301, 401 may comprise an antenna. A communication connection K4 can be established between the interface unit 131 of the modem 130 and the interface unit 301 of the infrared detector 300. In a corresponding manner, a communication connection K5 can be established between the interface unit 131 of the modem 130 and the interface unit 401 of the laser weapon 400.

In the example of a live simulation of a field exercise, the simulation information S1 indicates, for example, the shooting of a laser weapon 400 of the action force as a simulated shot or the detection of a laser beam with the infrared detector 300 attached to the action force as a simulated hit.

In particular, the modem 130 is in this case configured to modulate and provide a simulation signal S1 carrying the simulation information SI. Here, the simulation information SI is provided, for example, from the infrared detector 300 as a simulated hit. The modem 130 then transmits the modulated simulation signal S1 to the transceiver unit 120 of the mobile radio device 110. Here, the transceiver unit 120 is configured to transmit the modulated simulation signal S1 to the control center 200 optionally via each one of the at least two separate, independent communication connections K1, K2. In particular, the communication connection K1, K2 is selected in advance. The selection of the communication connection K1, K2 can be made, for example, by the communication device 100 or by the control center 200.

In FIG. 2, a schematic block diagram of a second embodiment of a communication device 100 for an action force for communicating with a control center 200 during a simulation of a security task is shown.

The second embodiment of FIG. 2 is based on the first embodiment of FIG. 1 and comprises all features of the first embodiment. In addition, FIG. 2 shows an external power supply device 500 which can be coupled to the mobile radio device 110 via a specific interface K6, for example USB. The power supply device 500 is, for example, an external powerbank. Such an external powerbank 500 has, for example, a capacity of 9000 mAh to 30000 mAh. Further, the external powerbank 500 has, for example, a size of 10 cm×5 cm×2 cm to 20 cm×15 cm×8 cm. The weight of such a powerbank 500 lies, for example, in the range of 200 g to 700 g.

In the embodiments of the FIG. 1 and FIG. 2, the modem 130 is integrated into the mobile radio device 110.

Furthermore, FIG. 3 shows a schematic block diagram of a third embodiment of a communication device 100 for an action force for communicating with a control center 200 during a simulation of a security task. The third embodiment of FIG. 3 differs from the first embodiment of FIG. 1 in that the modem 130 is arranged external to the mobile radio device 110. Here, the modem 130 is coupled to the mobile radio device 110 via a specific interface or communication connection K3. In order to constitute this coupling, the modem 130 and the transceiver unit 120 comprise each a corresponding interface unit 132 and 123. For example, the interface K3 is a Bluetooth interface or an USB interface.

In FIG. 4, a schematic block diagram of an embodiment of a mobile radio device 110 is shown which can be part of the communication device 100 according to FIG. 1, according to FIG. 2, or according to FIG. 3.

The mobile radio device 110 is, for example, configured as a smart phone. Here, the smart phone 110 includes a control computer 111 such as a micro controller. The control computer 111 is coupled to the transceiver unit 120 and the modem 130. Here, the control computer 110 is particularly configured to control the transceiver unit 120 and the modem 130. Furthermore, the smart phone 110 includes a gyro sensor 112, an acceleration sensor 113, a pedometer 114, a pulse monitor 115, an altimeter 116, a vibration signal generator 117, and a display 118. The display 118 is particularly configured as a touch sensitive display. More particular, the units 110 to 118 are coupled to the control computer 111.

FIG. 5 shows a schematic block diagram of a fourth embodiment of a communication device 100 for an action force for communicating with a control center 200 during a simulation of a security task.

The fourth embodiment of FIG. 5 is based on the third embodiment of FIG. 3. Alternatively, the fourth embodiment of FIG. 5 can also be based on the first embodiment of FIG. 1.

FIG. 5 further shows that the transceiver unit 120 is configured to receive voice and/or data signals S2 transmitted by the control center 200 optionally via each one of the at least two separate, independent communication connections K1, K2. Here, the modem 130 is configured to modulate the voice and/or data signals S2 received by the transceiver unit 120 and to transmit the modulated voice and/or data signals S2 to at least one output device 600. The output device 600 comprises for that purpose a specific interface unit 601 which can be coupled to the interface unit 131 of the modem 130 for establishing a communication connection K7. An example of such an output device 600 is shown in FIG. 6. The output device 600 comprises preferably a loudspeaker 602 and a display 603 for outputting the voice and data signals S2 transmitted by the modem 130.

FIG. 7 shows a schematic block diagram of a fifth embodiment of a communication device 100 for an action force for communicating with a control center 200 during a simulation of a security task. The fifth embodiment of FIG. 7 is based on the third embodiment of FIG. 3, but can alternatively be based on the first embodiment of FIG. 1 as well. Furthermore, the fifth embodiment of FIG. 7 can be combined with the fourth embodiment of FIG. 5.

Here, FIG. 7 shows that the transceiver unit 120 is configured to receive a control signal S3 for controlling the output device 600 transmitted by the control center 200 optionally via each one of the at least two separate, independent communication connections K1, K2. The modem 130 is then configured to modulate the control signal S3 received by the transceiver unit 120 and to transmit the modulated control signal S3 for controlling the output device 600 to the output device 600. FIG. 8 shows a schematic block diagram of a sixth embodiment of a communication device 100.

The sixth embodiment according to FIG. 8 is based on the third embodiment of FIG. 3, but can alternatively be based on the first embodiment of FIG. 1. Furthermore, the sixth embodiment of FIG. 8 can be combined with each of the embodiments of FIG. 5 and FIG. 7. FIG. 8 illustrates that an input device 700 is provided which is configured to provide voice and/or data signals S4 during a voice and/or data input by the action force. The input device 700 includes, for example, a head set and/or a further touch sensitive display. For establishing a communication connection K7 with the modem 130, the input device 700 has an interface unit 701 which can be coupled to the interface unit 131 of the modem 130. For that purpose, FIG. 9 shows an example of an input device 700. The input device 700 of FIG. 9 includes an interface unit 701, a microphone 702, a camera 703, and a touch sensitive display 704.

According to FIG. 8, the modem 130 is configured to modulate the voice and/or data signals S4 provided by the input device 700 and to transmit the modulated voice and/or data signals S4 to the transceiver unit 120. The transceiver unit 120 is then configured to transmit the modulated voice and/or data signals S4 to the control center 200 optionally via each one of the two separate, independent communication connections K1, K2.

FIG. 10 shows a schematic block diagram of an embodiment of a system 10 having a control center 200 and having a plurality of communication devices 100. Without loss of generality, the embodiment of FIG. 10 shows five communication devices 100 that are configured to form an ad-hoc network 800. The ad-hoc network 800 with the plurality of communication devices 100 is established via a communication connection K8 for a data exchange with the control center 200. Embodiments for the respective communication device 100 are depicted in FIG. 1, FIG. 2, FIG. 3, FIG. 5, FIG. 7, and FIG. 8.

In FIG. 11, a schematic flow chart of an embodiment of a communication method for communicating between a communication device 100 for an action force and a control center 200 during a simulation of a security task is illustrated.

The method of FIG. 11 includes the following method steps V1 and V2:

In step V1, the communication device 100 is equipped with a mobile radio device 110. The mobile radio device 110 includes a transceiver unit 120 for providing at least two separate, independent communication connections K1, K2 to the control center 200. Furthermore, the communication device 100 includes a modem 130 for coupling at least one detector 300 for detecting at least one simulation information SI regarding the simulation with the mobile radio device 100. Embodiments of the communication device 100 are shown in FIG. 1, FIG. 2, FIG. 3, FIG. 5, FIG. 7, and FIG. 8.

In step V2, voice and/or data signals S2 and/or a simulation signal S1 carrying the simulation information SI are transmitted optionally via each one of the at least two separate, independent communication connections between the transceiver unit 120 and the control center 200.

Although the present invention has been described in accordance with preferred embodiments, it can be modified in various manners.

### REFERENCE NUMERALS

10 system
100 communication device
101 wire-bound interface
110 mobile radio device
111 control computer
112 gyro sensor
113 acceleration sensor
114 pedometer
115 pulse monitor
116 altimeter
117 vibration signal generator
118 display
120 transceiver unit
121 interface unit
122 interface unit
123 interface unit
130 modem
131 interface unit
132 interface unit
200 control center
201 interface unit
202 interface unit
300 infrared detector
301 interface unit
400 laser weapon
401 interface unit
500 power supply unit
600 output device
601 interface unit
602 loudspeaker
603 display
700 input unit
701 interface unit
702 microphone
703 camera
704 touch sensitive display
800 ad-hoc network
K1 communication connection
K2 communication connection
K3 communication connection
K4 communication connection
K5 communication connection
K6 interface
K7 communication connection
K8 communication connection
SI simulation information
S1 simulation signal
S2 voice and/or data signal
S3 control signal
S4 voice and/or data signal
V1 method step
V2 method step

1. A communication device (100) for an action force for communicating with a control center (200) during a simulation of a security task, with:
a mobile radio device (110) having a transceiver unit (120) for providing at least two separate, independent communication connections (K1, K2) to the control center (200), and
a modem (130) for coupling at least one detector (300) for detecting at least one simulation information (SI) regarding the simulation with the mobile radio device (110).

2. The communication device according to claim 1,
characterized in that,
the modem (130) is configured to modulate a simulation signal (S1) carrying the simulation information (SI) and to transmit the modulated simulation signal (S1) to the transceiver unit (120), wherein the transceiver unit (120) is configured to transmit the modulated simulation signal (S1) to the control center (200) optionally via each one of the at least two separate, independent communication connections (K1, K2).

3. The communication device according to claim 1 or 2,
characterized in that,
the modem (130) is configured to couple a number of infrared detectors (300) and a number of laser weapons (400) to the mobile radio device (110).

4. The communication device according to any one of the claims 1 to 3,
characterized in that,
the mobile radio device (110) is configured to use different communication standards for establishing the at least two separate, independent communication connections (K1, K2).

5. The communication device according to any one of the claims 1 to 4,
characterized in that,
the mobile radio device (110) is a smart phone which preferably includes a gyro sensor (112), an acceleration sensor (113), a pedometer (114), a pulse monitor (115), an altimeter (116), and/or a vibration signal generator (117).

6. The communication device according to any one of the claims 1 to 5,
characterized in that,
the modem (130) is integrated into the mobile radio device (110) or the modem (130) is arranged external to the mobile radio device (110) and is coupleable to the mobile radio device (110) via a first specific interface (K3), preferably via Bluetooth or via USB.

7. The communication device according to any one of the claims 1 to 6,
characterized by
an external power supply unit (500), preferably an external powerbank, which is coupleable to the mobile radio device (110) via a second specific interface (K6).

8. The communication device according to any one of the claims 1 to 7,
characterized in that,
the transceiver unit (120) is configured to receive voice and/or data signals (S2) transmitted from the control center (200) optionally via each one of the at least two separate, independent communication connections (K1, K2), wherein the modem (130) is configured to modulate the voice and/or data signals (S2) received by the transceiver unit (120) and to transmit the modulated voice and/or data signals (S2) to at least one output device (600).

9. The communication device according to claim 8,
characterized in that,
the output device (600) comprises a loudspeaker (602) and/or a display (603) for outputting the voice and/or data signals (S2) transmitted by the modem (130).

10. The communication device according to claim 8 or 9,
characterized in that,
the transceiver unit (120) is configured to receive, optionally via each one of the at least two separate, independent communication connections (K1, K2), a control signal (S3) for controlling the output device (600) transmitted by the control center (200), wherein the modem (130) is configured to modulate the control signal (S3) received by the transceiver unit (120) and to transmit the modulated control signal (S3) for controlling the output device (600) to this output device (600).

11. The communication device according to any one of the claims 1 to 10,
characterized by
at least one input device (700) for providing voice and/or data signals during a voice and/or data input by the action force.

12. The communication device according to claim 11,
characterized in that,
the input device (700) includes a microphone (702), a camera (703), and/or a touch sensitive display (704).

13. The communication device according to claim 11 or 12,
characterized in that,
the modem (130) is configured to modulate the voice and/or data signals (S4) provided by the input device (700) and to transmit the modulated voice and/or data signals (S4) to the transceiver unit (120), wherein the transceiver unit (120) is configured to transmit the modulated voice and/or data signals (S4) to the control center (200) optionally via each one of the at least two separate, independent communication connections (K1, K2).

14. A system (10) having a control center (200) and having a plurality of communication devices (100) according to any one of the claims 1 to 13, which are preferably configured to establish an ad-hoc network (800).

15. A communication method for communicating between a communication device (100) for an action force and a control center (200) during a simulation of a security task, with:
equipping (V1) the communication device (100) with a mobile radio device (110) which comprises a transceiver unit (120) for providing at least two separate, independent communication connections (K1, K2) to the control center (200) and with a modem (130) for coupling at least one detector (300) for detecting at least one simulation information (SI) relating to the simulation with the mobile radio device (110), and
transmitting (V2) voice and/or data signals (S2) and/or a simulation signal (S1) carrying the simulation information (SI) optionally via each one of the at least two separate, independent communication connections (K1, K2) between the transceiver unit (120) and the control center (200).
